(19) United States
(12) Patent Application Publication
(10) Pub. No.: US 2024/0080778 A1
(43) Pub. Date: Mar. 7, 2024

(54) USING WI-FI LOCATION INFORMATION TO REFINE A WI-FI 6 GHZ AFC REQUEST

(71) Applicant: ARRIS Enterprises LLC, Suwanee, GA (US)

(72) Inventors: Jay W. STRATER, San Diego, CA (US); Gregory N. NAKANISHI, San Diego, CA (US); Kurt A. LUMBATIS, Dacula, GA (US); James R. FLESCH, Doraville, GA (US)

(21) Appl. No.: 18/140,090

(22) Filed: Apr. 27, 2023

Related U.S. Application Data
(60) Provisional application No. 63/337,670, filed on May 3, 2022.

(51) Int. Cl. H04W 52/36; H04W 52/28

(52) U.S. Cl. CPC H04W 52/367; H04W 52/283

(57) ABSTRACT

An enhanced network environment is provided by configuring an indoor access point device in a region subject to AFC constraints to utilize the 6 GHz frequency band. The access point device requires configuration so as not to interfere with incumbent 6 GHz wireless infrastructures or systems. The configuring includes obtaining location information using Wi-Fi Location functionality to obtain one or more associated range measurements so as to determine an accurate access point device location. This location can then be sent as part of an AFC request message to an AFS management system to obtain a power allowance. Once configured, the access point device can be registered with the AFC resource and can operate at a power allowance that can be higher than the power allowance associated with the standard power or low power indoor.

### BACKGROUND

Companies are increasingly providing Multiple Access Point (MAP) architecture or Home Network Controller (HNC) type of home wireless fidelity (Wi-Fi) management, with multiple access point devices and/or extender access point devices (collectively, network devices) at a premises, for example, a home, to improve Quality of Experience (QoE) of the user by offering extended coverage with seamless roaming. Access point devices and extender access point devices communicate with client devices using one or more RF channels. Typically, 5 GigaHertz (GHz) radio is used for Wi-Fi backhaul in extender access point devices because such offers more bandwidth with less interference and greater reliability when compared to 2.4 GHz radio. However, network architecture and user demands are creating a crowded space even for the 5 GHz frequency band. Even in the network environments where relatively high bitrate streaming traffic is shunted off of the 2.4 GHz frequency band to the 5 GHz frequency band, crowding in both pieces of the spectrum is becoming everyday more commonplace.

The 6 GHz frequency band for Wi-Fi 6E is providing some relief for the overcrowding of the 2.4 GHz and 5 GHz frequency bands. However, incumbent 6 GHz wireless infrastructures or systems, such as a fixed microwave system, may be located within a proximity of an indoor network device such that operation in the 6 GHz frequency band can be restricted by a governmental agency or regulatory group, such as by the Federal Communications Commission (FCC), to low power indoor (LPI) transmission levels when the device might otherwise be allowed to operate with higher Standard Power (SP) transmission levels in portions of the 6 GHz frequency band (for example, U-NII 5 and U-NII 7). If a network device is near but not in the path of an incumbent 6 GHz wireless infrastructure or systems, the network device can be restricted to low power indoor (LPI) transmission levels on all 6 GHz channels unless the network device can provide an accurate indication of the network device location to an Automated Frequency Coordination (AFC) management system that allocates transmission allowances. Therefore, providing accurate location information for an indoor network device so as to enhance the Wi-Fi network experience for users by achieving higher power within portions of the 6 GHz frequency band, even when the users are near but not interfering with incumbent 6 GHz wireless infrastructures or systems.

### SUMMARY

Network environments, especially home network environments, can now serve multiple functions for various types of users and network devices. For example, the same network can be required support a variety of users that require differing amounts of access and bandwidth and multiple network. Given the various network activities that include substantial reliance on Internet access, especially indoor Wi-Fi or Internet access, and increased access to network resources, it is becoming imperative to provide the best optimized access to the network for all users and/or network devices seeking access to any number of network resources. With the availability of 6 GHz for Wi-Fi 6E and later solutions, an access point device can be developed to support 6 GHz frequency band over any of the Unlicensed National Information infrastructure (U-NII) 5, 6, 7, and 8 bands or any other U-NII band. However, use of the 6 GHz frequency band is restricted by the FCC (or one or more other governmental agencies) to LPI transmission levels without being under the control of an automated frequency coordination (AFC) management system, for example, to the maximum allowed equivalent isotropic radiated power (EIRP) of 30 decibel (dB)-milliwatts (dBm) or 5 dBn/MHz (MegaHertz) power spectral density. There is an option for a higher Standard Power (SP) transmission levels for an access point device in the U-NII 5 and U-NII 7 bands indoors, for example, an effective isotropic radiated power (EIRP) of 36 dBm or maximum spectrum density of 23 dBm/M Hz. However, this requires operation under the control of an AFC management system which maintains a database of the frequencies used by and geographical locations of the incumbent infrastructures or system. The AFC management system will assign a list of frequencies and transmission levels to the access point device, based on where the access point device can operate safely without interfering with any incumbent systems or infrastructures (for example fixed microwave receiver).

The Wi-Fi Alliance (WFA) developed an AFC management system to AFC Device Interface Specification to standardize the signaling needed for communication between an access point device and an AFC management system. This specification includes fields for information associated with a location of the access point device (an access point device location) to be sent or transmitted by or for an access point device in an AFC request message, such as an available spectrum inquiry message. An AFC request message comprises an uncertainty region within which the access point device is located (a location error) based on the information associated with the access point device location. This uncertainty region can be defined as an ellipse, a linear polygon, a radial polygon, or any other shape. In certain circumstances, a large uncertainty region associated with an access point device is acceptable. However, when an access point device is disposed or positioned in proximity to, but not in the path of, an incumbent fixed microwave receiver, the accuracy of the uncertainty region is important such that the accuracy should be maximized so that the restriction on SP power allocation is minimized.

One or more novel solutions of the present disclosure provide for location information associated with an access point device to comprise global position system (GPS) information obtained from a client device (such as any type of mobile device) and WFA Wi-Fi Location information between the client device and the access point device. Using such accurate location information minimizes a user involvement in a determination of an access point device location while also providing for assignment of a higher power allowance from an AFC management system.

An aspect of the present disclosure provides a method for a client device to configure a power allowance for an access point device. The method comprises receiving one or more global positioning system (GPS) measurements associated with the client device, receiving one or more associated range measurements to the access point device via a wireless fidelity (Wi-Fi) Location Fine Timing functionality, wherein the one or more associated range measurements are associated with the one or more GPS measurements, determining an access point device location associated with the access point device based on the one or more GPS measurements and the one or more associated range measurements, sending an AFC request message to an AFC management system, wherein the AFC request message is based on the access point device location, receiving an AFC response message from the AFC management system, wherein the AFC response message comprises the power allowance for the access point device, and configuring the access point device based on the AFC response message.

In an aspect of the present disclosure, the method is such that the message is such that wherein the AFC response message comprises a maximum transmit power allowance for the access point device, wherein configuring the access point device comprises providing the maximum transmit power allowance to the access point device.

In an aspect of the present disclosure, the method further comprises sending a notification to a user to transition the client device prior to receiving the one or more GPS measurements, the one or more additional GPS measurements, or both.

In an aspect of the present disclosure, the method further comprises receiving one or more additional GPS measurements associated with the client device, receiving one or more additional associated range measurements to the access point device, wherein the one or more additional associated range measurements are associated with the one or more additional GPS measurements, and wherein determining the access point device location is based on a triangulation of the one or more GPS measurements, the one or more additional GPS measurements, the one or more associated range measurements, and the one or more additional associated range measurements.

In an aspect of the present disclosure, the method further comprises receiving a height information from a network resource based on a latitude and a longitude associated with the access point device location, wherein the latitude and the longitude are based on the one or more GPS measurements, the one or more additional GPS measurements, or both.

In an aspect of the present disclosure, the method is such that wherein receiving the client device location comprises receiving a user input, wherein the user input is indicative of any of an address, a zip code, information from a provider database, or any combination thereof associated with the access point device, the client device, or both.

In an aspect of the present disclosure, the method further comprises receiving a serial number and a media access control (MAC address) via a user interface of the client device, wherein the AFC request message comprises the serial number and the MAC address.

An aspect of the present disclosure provides a client device that comprises a memory and a processor. The memory storing one or more computer-readable instructions and the processor configured to execute the one or more computer-readable instructions to cause the access point device to execute the one or more computer-readable instructions to receive one or more global positioning system (GPS) measurements associated with the client device, receive one or more associated range measurements to the access point device via a wireless fidelity (Wi-Fi) Location Fine Timing functionality, wherein the one or more associated range measurements are associated with the one or more GPS measurements, determine an access point device location associated with the access point device based on the one or more GPS measurements and the one or more associated range measurements, send an AFC request message to an AFC management system, wherein the AFC request message is based on the access point device location, receive an AFC response message from the AFC management system, wherein the AFC response message comprises the power allowance for the access point device, and configure the access point device based on the AFC response message.

In an aspect of the present disclosure, the AFC response message comprises a maximum transmit power allowance for the access point device, wherein configuring the access point device comprises providing the maximum transmit power allowance to the access point device.

In an aspect of the present disclosure, the processor is further configured to execute the one or more instructions to further cause the client device to send a notification to a user to transition the client device prior to receiving the one or more GPS measurements, the one or more additional GPS measurements, or both.

In an aspect of the present disclosure, the processor is further configured to execute the one or more instructions to further cause the client device to receive one or more additional GPS measurements associated with the client device, receive one or more additional associated range measurements to the access point device, wherein the one or more additional associated range measurements are associated with the one or more additional GPS measurements, and wherein determining the access point device location is based on a triangulation of the one or more GPS measurements, the one or more additional GPS measurements, the one or more associated range measurements, and the one or more additional associated range measurements. 10017) In an aspect of the present disclosure, the processor is further configured to execute the one or more instructions to further cause the client device to receive a height information from a network resource based on a latitude and a longitude associated with the access point device location, wherein the latitude and the longitude are based on the one or more GPS measurements, the one or more additional GPS measurements, or both.

In an aspect of the present disclosure, wherein receiving the client device location comprises receiving a user input, wherein the user input is indicative of any of an address, a zip code, information from a provider database, or any combination thereof associated with the access point device, the client device, or both.

In an aspect of the present disclosure, the processor is further configured to execute the one or more instructions to further cause the client device to receive a serial number and a media access control (MAC address) via a user interface of the client device, and wherein the AFC request message comprises the serial number and the MAC address.

An aspect of the present disclosure provides a non-transitory computer-readable medium of a client device storing one or more computer-readable instructions for configuring a power allowance for an access point device. The one or more computer-readable instructions, that when executed by a processor, cause the processor to perform one or more operations including the steps of the methods described above.

The above-described network device(s) or electronic apparatus(es), such as access point devices, extender access point devices, client devices and any other network devices, may be implemented as any of a residential network access point device, an electronic device (for example, a mobile phone, a computing device such as a notebook computer, or both) according to one or more embodiments.

Thus, according to various aspects of the present disclosure described herein, it is possible to configure an access point device to utilize the 6 GHz frequency band of a network without interfering with incumbent 6 GHz wireless infrastructures or systems within proximity of the access point device based on a determination of an improved or accurate access point device location.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, client device, and extender access point device implemented in the network environment of FIG. 1, according to one or more aspects of the present disclosure;

FIG. 3 is a more detailed block diagram illustrating a client device for use in obtaining location information of an access point device of a network, according to one or more aspects of the present disclosure; and

FIGS. 4A and 4B illustrate a flow diagram for configuring 6 GHz transmission power of an access point device in a network environment, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

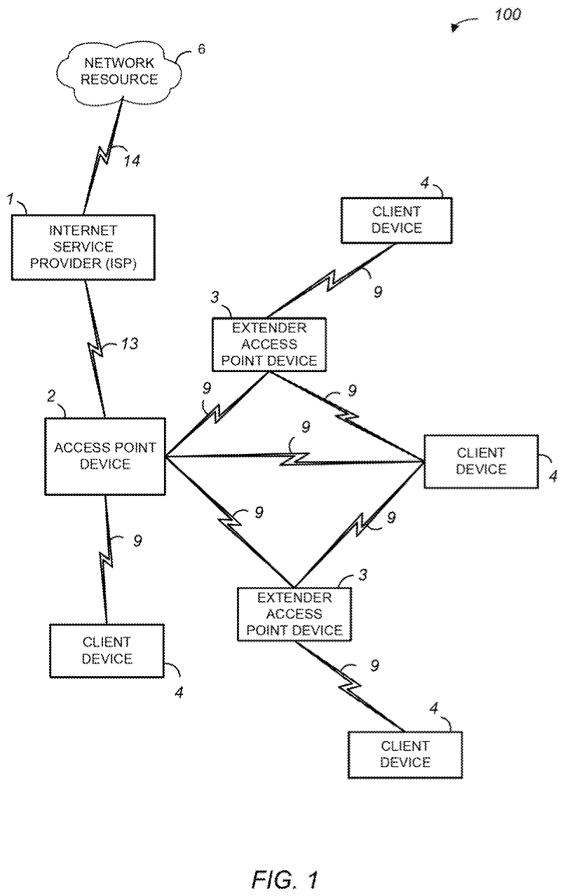

FIG. 1 is a schematic diagram of a network environment 100, according to one or more aspects of the present disclosure.

It should be appreciated that various example embodiments of inventive concepts disclosed herein are not limited to specific numbers or combinations of devices, and there may be one or multiple of some of the aforementioned electronic apparatuses or network devices in the network environment, which may itself consist of multiple communication networks and various known or future developed wireless connectivity technologies, protocols, devices, and the like.

As shown in FIG. 1, the main elements of the network environment 100 include a network comprising an access point device 2 connected to a network resource 6, such as a cloud-based repository, via an Internet Service Provider (ISP) 1 and also connected to different wireless devices or network devices such as one or more wireless extender access point devices 3 and one or more client devices 4. The network environment 100 shown in FIG. 1 includes wired and/or wireless network devices (e.g., extender access point devices 3 and client devices 4) that may be connected in one or more wireless networks (e.g., private, guest, iControl, backhaul network, or Internet of things (IoT) network) within the network environment 100. Additionally, there could be some overlap between network devices (e.g., extender access point devices 3 and client devices 4) in the different networks. That is, one or more network or wireless devices could be located in more than one network. For example, the extender access point devices 3 could be located both in a private network for providing content and information to a client device 4 and also included in a backhaul network or an iControl network.

The ISP 1 can be, for example, a content provider or any computer for connecting the access point device 2 to the network resource 6. For example, network resource 6 can be a cloud-based service that provides access to a cloud-based repository, a governmental or other database, such as an AFC database (for example, an AFC resource associated with an AFC management system), that provides information associated with operations within the 6 GHz wireless frequency band, a location service for providing topographical information, for example, topographical information associated with a coordinate, such as a z-coordinate associated with a location indicated by an x-y coordinate, any other repository, or any combination thereof that is accessible via ISP 1. In one or more embodiments, network resource 6 may be accessible via a cellular communications service provider. The connection 14 between the network resource 6 and the ISP 1 and the connection 13 between the ISP 1 and the access point device 2 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3^{rd} Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example.

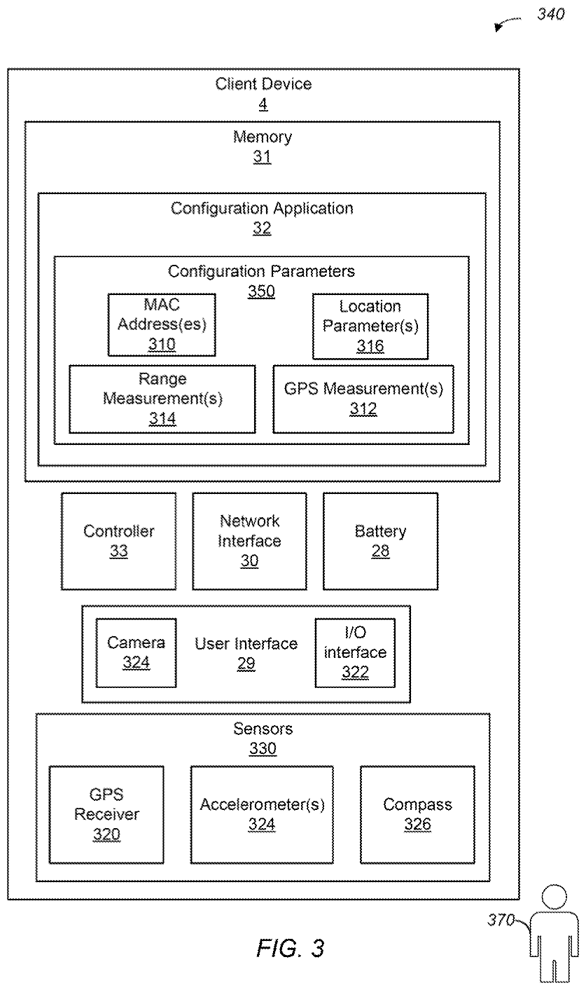

The access point device 2 can be, for example, an access point and/or a hardware electronic device that may be a combination modem and gateway that combines the functions of a modem, an access point (AP), and/or a router for providing content received from the ISP 1 to one or more network devices (e.g., wireless extender access point devices 3 and client devices 4) in the network environment 100. In one or more embodiments, the access point device 2 has a transmission power (Tx) configured for the access point device 2 beyond LPI power levels based on AFC feedback (for example, an AFC response message) for a location of the access point device 2 determined by a configuration application 32 of a client device 4 as discussed with reference to FIGS. 3-5. It is also contemplated by the present disclosure that the access point device 2 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (or) or multiple system operator (MSO) provided content. The access point device 2 may also be referred to as a residential gateway, a home network gateway, or a wireless access point (AP).

The connection 9 between the access point device 2, the wireless extender access point devices 3, and client devices 4 can be implemented using a wireless connection in accordance with any IEEE 802.11 Wi-Fi protocols, Bluetooth protocols, BLE, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information on any of one or more channels that are available for use. Connection 9 can be a secure connection that prevents or thwarts unauthorized or unwanted access.

The extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, client devices 4, which may be out of range of the access point device 2. The extender access point devices 3 can also receive signals from the client devices 4 and rebroadcast the signals to the access point device 2, or other client devices 4.

The client devices 4 can be, for example, hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of accessing a wireless network. For example, any one or more client devices 4 can be a mobile network device capable of connecting to a wireless network and configuring a transmission power of an access point device 2 that is beyond LPI power levels based on AFC feedback for a location determined for the access point device 2 by the client device 4. Additionally, any one or more client devices 4 can be a television (TV), an IP/QAM set-top box (STB) or a streaming media decoder that is capable of decoding audio/video content, and playing over OTT or MSO provided content received through the access point device 2. In one or more embodiments, a client device 4 is a network device that comprises a configuration application 32 (as discussed with reference to FIG. 3) for configuring an access point device 2 to operate at a power allowance based on location information associated with the access point device, such as a Wi-Fi location information (including, but not limited to, one or more Wi-Fi Location Fine Timing range measurements), one or more GPS measurements, any other information, or any combination thereof.

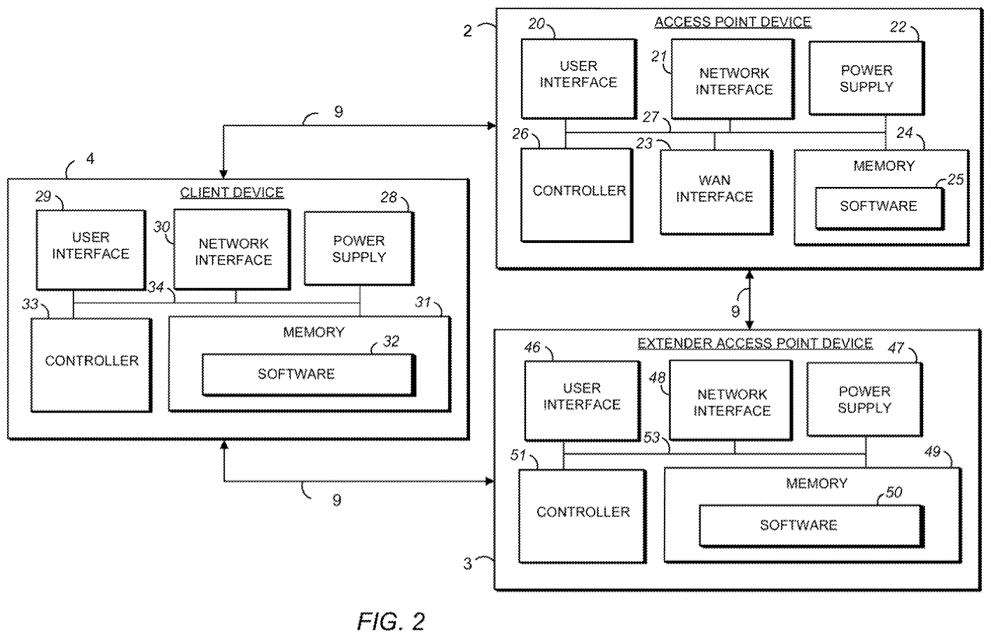

A detailed description of the exemplary internal components of the access point device 2, the extender access point devices 3, and the client devices 4 shown in FIG. 1 will be provided in the discussion of FIG. 2. However, in general, it is contemplated by the present disclosure that the access point device 2, the extender access point devices 3, and the client devices 4 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (e.g., a non-transitory computer-readable medium).

Further, any, all, or some of the computing components in the access point device 2, the extender access point devices 3, and the client devices 4 may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the client devices 4 are further equipped with components to facilitate communication with other computing devices or network devices over the one or more network connections to local and wide area networks, wireless and wired networks, public and private networks, and any other communication network enabling communication in the network environment 100.

FIG. 2 is a more detailed block diagram illustrating various components of an exemplary access point device, client device, and wireless extender implemented in the network environment 100 of FIG. 1, according to one or more aspects of the present disclosure.

Although FIG. 2 only shows one extender access point device 3 and one client device 4, the extender access point device 3 and the client device 4 shown in the figure are meant to be representative of the other extender access point devices 3 and client devices 4 of a network system, for example, network environment 100 shown in FIG. 1. Similarly, the connections 9 between the access point device 2, the extender access point device 3, and the client device 4 shown in FIG. 2 are meant to be exemplary connections and are not meant to indicate all possible connections between the access point devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 27.

The client device 4 includes a power supply 28, a user interface 29, a network interface 30, a memory 31, and a controller 33. The client device 4 can be, for example, a computer, a portable device, an electronic tablet, an e-reader, a PDA, a mobile phone such as a smart phone, a smart speaker, an IoT device, an iControl device, portable music player with smart capabilities capable of connecting to the Internet, cellular networks, interconnecting with other devices via Wi-Fi and Bluetooth, any network device capable of receiving and/or generating one or more GPS measurements, or other wireless hand-held consumer electronic device capable of communicating with access point device 2, a network resource 6 or any other network device. In one or more embodiments, a client device 4 is a mobile network device, such as a smart phone, capable of configuring an access point device 2 such that the access point device 2 can provide a 6 GHz wireless frequency band network. The client device 4 can communicate with one or more resources 6 to obtain the necessary information for configuration of the access point device 2, according to one or more aspects of the present disclosure.

The power supply 28 supplies power to the internal components of the client device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user 370 and the client device 4, for example, for a user 370 to enter any one or more parameters that can be stored in memory 31, such as one or more location parameters 316 of an access point device 2 as discussed with reference to FIG. 3. In one or more embodiments, user interface 29 provides an interface for a user 370, such as a graphical user interface, to interact with a configuration application, for example, software 32, to configure or commission an access point device 2 to provide a 6 GHz wireless frequency band network. The network interface 30 can include, but is not limited to, various network cards, interfaces, and circuitry implemented in software and/or hardware to enable communications with the access point device 2, the extender access point device 3, ISP 1, and/or network resource 6 using any one or more of the communication protocols in accordance with connection 9 (for example, as described with reference to FIG. 1).

The memory 31 includes a single memory, one or more memories, or one or more memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, software 32 can be a configuration application. Memory 31 can store the configuration application 32 and information used by the configuration application 32 to configure an access point device 2 to utilize the 6 GHz wireless frequency band at a power level that does not interfere with an incumbent fixed microwave receiver also referred to as an incumbent 6 GHz wireless infrastructures or systems. In one or more embodiments, client device 4 is a network device, such as a mobile or smart phone, and configuration application 32 includes one or more computer-readable instructions for establishing a connection with the access point device 2 so that the configuration application 32 can any of determine a location associated with the access point device 2, receive one or more measurements associated with a location of the access point device 2 (such as, any of one or more GPS measurements, one or more Wi-Fi Location Fine Timing measurements, any other measurements (such as information from a network resource 6), or any combination thereof), determine a signal strength associated with the access point device 2, obtain any other information, make any other determination associated with configuring the access point device 2, configure the access point device 2, or any combination thereof. Information can include data or information associated with configuring the access point device 2, for example, any of topographical data, EIRP data, power allowance, any other coordinate information, or a combination thereof.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure, such as configuring access point device 2. Communication between the components (for example, 28-31 and 33) of the client device 4 may be established using an internal bus 34.

As shown in FIG. 2, the extender access point device 3 includes a user interface 46, a power supply 47, a network interface 48, a memory 49, and a controller 51. The extender access point device 3 can be, for example, any wireless hardware electronic device used to extend a wireless network by receiving the signals transmitted by the access point device 2 and rebroadcasting the signals to any one or more client devices 4, which may be out of range of the access point device 2 including, but not limited to, a wireless extender, a repeater, and/or an access point. The extender access point device 3 can also receive signals from any one or more of the client devices 4 and rebroadcast the signals to the access point device 2 or any other one or more client devices 4.

The user interface 46 can include, but is not limited to, one or more push buttons, a keyboard, a keypad, an LCD, a TFT, an LED, an HD or other similar display device including a display device having touch screen capabilities so as to allow interaction between a user and the extender access point device 3. The power supply 47 supplies power to the internal components of the wireless extender access point device 3 through the internal bus 53. The power supply 47 can be connected to an electrical outlet (e.g., either directly or indirectly by way of another device) via a cable or wire. The network interface 48 can include various network cards, interfaces, and circuitry implemented in software and/or hardware to enable communications with the client device 4 and the access point device 2 using the communication protocols in accordance with connection 9 (for example, as described with reference to FIG. 1). For example, the network interface 48 can include multiple radios or sets of radios (for example, a 2.4 GHz radio, one or more 5 GHz radios, and/or a 6 GHz radio), which may also be referred to as wireless local area network (WLAN) interfaces. One radio or set of radios (for example, 5 GHz and/or 6 GHz radio(s)) provides a backhaul connection between the wireless extender access point device 3 and the access point device 2, and optionally other wireless extender access point device(s) 3. Another radio or set of radios (for example, 2.4 GHz, 5 GHz, and/or 6 GHz radio(s)) provides a fronthaul connection between the extender access point device 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the wireless extender access point device 3 in accordance with the embodiments described in the present disclosure. In one or more embodiments, extender access point device 3 is a network device and software 50 includes one or more instructions for establishing a connection with the access point device 2 and/or a client device 4.

The controller 51 controls the general operations of the wireless extender access point device 3 and can include, but is not limited to, a CPU, a hardware microprocessor, a hardware processor, a multi-core processor, a single core processor, an FPGA, a microcontroller, an ASIC, a digital signal processor (DSP), or other similar processing device capable of executing any type of instructions, algorithms, or software for controlling the operation and functions of the wireless extender access point device 3 in accordance with the embodiments described in the present disclosure. General communication between the components (for example, 46-51) of the extender access point device 3 may be established using the internal bus 53.

The access point device 2 can be, for example, a hardware electronic device that can combine one or more functions of any of a modern, a gateway, an access point (AP), a router, or combinations thereof for providing content received from the content provider (ISP) 1 to network or wireless devices (for example, extender access point devices 3, client devices 4) in the system. It is also contemplated by the present disclosure that the access point device 2 can include the function of, but is not limited to, an IP/QAM STB, an SM D, or any other decoder that is capable of decoding audio/video content, and playing OTT or MSO provided content.

As shown in FIG. 2, the access point device 2 includes a user interface 20, a network interface 21, a power supply 22, a wide area network (WAN) interface 23, a memory 24, and a controller 26. The user interface 20 can include, but is not limited to, one or more push buttons, a keyboard, a keypad, an LCD, a TFT, an LED, an HD or other similar display device including a display device having touch screen capabilities so as to allow interaction between a user and the access point device 2. In one or more embodiments, the user interface 20 provides an interface, such as a command-line interface, a graphical user interface, an interface output port for connection to a display, and/or any other type of user interface. In one or more embodiments, access point device 2 communicates with a client device 4 to provide information associated with a location of the access point device 2 such that the client device 4 can obtain a power allowance so as to configure the access point device 2, according to one or more aspects of the present disclosure.

The network interface 21 may include various network cards, and circuitry implemented in software and/or hardware to enable communications with the extender access point device 3 and the client device 4 using the communication protocols in accordance with connection 9 (for example, as described with reference to FIG. 1). Additionally, the various network cards, interfaces, and circuitry of the network interface 21 enable communications with a client device 4 (for example, a mobile device) using the one or more communication protocols in accordance with connection 9 (for example, as described with reference to FIG. 1). For example, the network interface 21 can include an Ethernet port (also referred to as a LAN interface) and multiple radios or sets of radios (for example, a 2.4 GHz radio, one or more 5 GHz radios, and/or a 6 GHz radio, also referred to as WLAN interfaces). One radio or set of radios (for example, 5 GHz and/or 6 GHz radio(s)) provides a backhaul connection between the access point device 2 and the wireless extender access point device(s) 3. Another radio or set of radios (for example, 2.4 GHz, 5 GHz, and/or 6 GHz radio(s)) provides a fronthaul connection between the access point device 2 and one or more client device(s) 4. In one or more embodiments, the network interface 21 interfaces with a network resource 6.

The power supply 22 supplies power to the internal components of the access point device 2 through the internal bus 27. The power supply 22 can be connected to an electrical outlet (for example, either directly or by way of another device) via a cable or wire. The wide area network (WAN) interface 23 may include various network cards, and circuitry implemented in software and/or hardware to enable communications between the access point device 2 and the ISP 1 using the wired and/or wireless protocols in accordance with connection 9 (for example, as described with reference to FIG. 1).

The memory 24 includes a single memory, one or more memories, or one or more memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for providing a 6 GHz wireless frequency network based on a configuration (such as configuration application 32 that utilizes one or more configuration parameters 350 as discussed with reference to FIG. 3) by a client device 4. The controller 26 controls the general operations of the access point device 2 as well as connectivity to the network by one or more other network devices (wireless extender access point devices 3 and client device 4). The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the software 25 in accordance with the embodiments described in the present disclosure. Communication between the components (for example, 20-24, and 26) of the access point device 2 may be established using the internal bus 27. The controller 26 may also be referred to as a processor, generally.

FIG. 3 is a more detailed block diagram illustrating certain components of an exemplary client device 4 implemented in the network environment of FIG. 1 and in FIG. 2, according to one or more aspects of the present disclosure.

As shown in FIG. 3, the client device 4 includes a memory 31, a controller 33, a network interface 30, a power supply 28 (such as a rechargeable battery), a user interface 29, for example, a camera 324 (or any other device for receiving/recording a visual image) and/or an input/output (I/O) interface 322, and one or more sensors 330. The one or more sensors 330 can include a global positioning system (GPS) receiver 320, one or more accelerometers 324, a compass or magnetometer 326, any other sensor, or any combination thereof. In one or more embodiments, any of the one or more sensors 330 can be part of a single device or one or more devices. The memory 31 can be a computer-readable memory for storing software or one or more computer-readable instructions executable by the controller 33. For example, a configuration system 340 can comprise hardware, software, or both and can include, but is not limited to, a configuration application 32 and one or more configuration parameters 350 for use by the configuration application 32, for example, any one or more measurements or data received from any of the one or more sensors 330, an access point device 2, a network resource 6, a database, any other network device capable of sending one or more measurements or data associated with a location and/or a power allowance associated with the access point device 2, or any combination thereof.

Any one or more of the components of the configuration application 32 can be implemented by software, hardware, or a combination thereof. In one or more embodiments, any one or more components of configuration application 32 are included within single component or multiple components. The one or more configuration parameters 350 can include one or more media access control (MAC) addresses 310, one or more GPS measurements 312, one or more Wi-Fi Location Fine Timing range measurements 314, and one or more location parameters 316. The one or more MAC addresses 310 are MAC addresses associated with any one or more access point devices 2. In one or more embodiments, the MAC address 310 is associated with a corresponding serial number of the access point device 2 with the serial number stored as part of or associated with the MAC address 310. The one or more GPS measurements 312 can comprise associated with a location of the client device 4, including, but not limited to, any of a latitude, a longitude, a height, an angle, any other GPS measurements, or any combination thereof. The one or more GPS measurements 312 can be determined or obtained based on information received from the GPS receiver 320. For example, the configuration application 32 can receive from a GPS receiver 320 one or more coordinates associated with a current position of the client device 4 and store the coordinates as a GPS measurement 312. Each of the one or more GPS measurements 312 can have an associated one or more radio signal strength indicator measurement. The one or more range measurements 314 can comprise one or more Wi-Fi Fine Timing range measurements from one or more access points 2 via Wi-Fi Location functionality. The one or more Wi-Fi Fine Timing range measurements can be associated with one or more GPS measurements 312. The location parameter 316 can comprise one or more parameters associated with a location of the client device 4 and/or the access point device 2, such as any of a height, an address (including but not limited to, any of a street, a city, a zip code, a user name, or any combination thereof), a location error, any other location identifying information, or any combination thereof.

Any one or more of the location parameters 316 can be received as a user input via the I/O interface 322. In one or more embodiments, the user interface 29 includes a display and a graphical user interface or any other type of user interface. The configuration application 32 can send one or more prompts to the user interface 29 that requests information from or provides information to a user of the client device 4, for example, one or more location parameters 316.

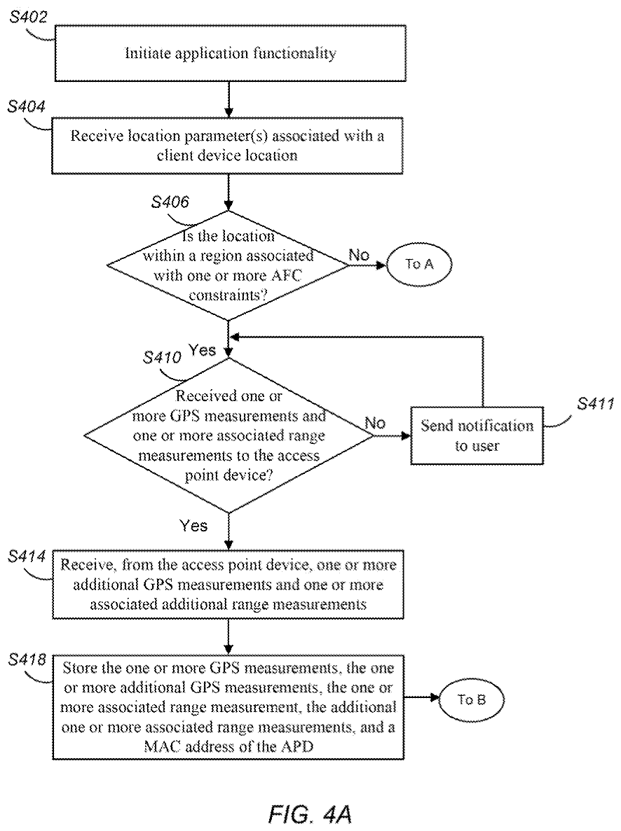

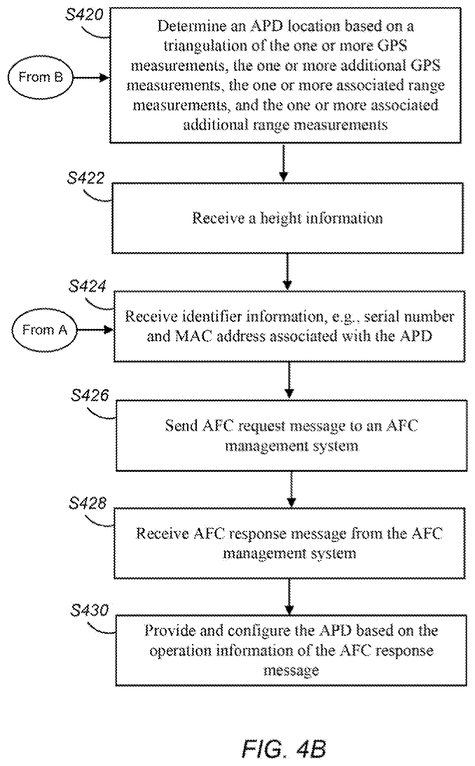

FIGS. 4A and 4B illustrate a flow diagram for configuring an access point device 2 of a network environment, such as network environment 100, according to one or more aspects of the present disclosure.

The client device 4 may comprise a configuration system 340 that is programmed with one or more computer-readable instructions such as a configuration application 32 that when executed by a controller 33 cause the client device 4 (for example, the configuration system 340) to provide configuration of an access point device 2 according to one or more embodiments so as to provide an enhanced QoE for users of a network environment by allowing for exploit of a 6 GHz frequency band, for example, to allow an access point device 2 to operate at an increased power allowance (for example, at SP) than the LPI power allowance when the access point device 2 is within a region with AFC constraints. In FIGS. 4A and 4B, it is assumed that any one or more of the devices include their respective controllers and their respective software stored in their respective memories, as discussed above in connection with FIGS. 1-3, which when executed by their respective controllers perform the functions and operations in accordance with the example embodiments of the present disclosure (for example, including performing a configuration of one or more network devices). While the steps S402-S430 are presented in a certain order, the present disclosure contemplates that any one or more steps can be performed simultaneously, substantially simultaneously, repeatedly, in any order or not at all (omitted).

At step S402, the client device 4 initiates application functionality. For example, a user can download a configuration application 32 to the client device 4 or any other network device for use in setting up a Wi-Fi network. Setting up the Wi-Fi network can comprise an initial setup or a post-setup that includes determining a location of one or more access point devices 2 (including one or more access point device locations) to use with configuring the access point device 2 with a transmit power as allocated by an AFC management system. Determining the location of the one or more access point devices 2 (the one or more access point device locations) comprises determining any of an x-coordinate, a y-coordinate, a z-coordinate, a location error, or any combination thereof. Initiating the configuration application 32 can comprise enabling any of a GPS receiver 320 (so as to obtain or receive one or more GPS measurements), a network interface 30 functionality (for example, to allow for access to a Wi-Fi network so as to communicate wirelessly with an access point device 2) or access to a camera 324, any other functionality, or any combination thereof. The client device 4 includes capability for support of Wi-Fi Location functionality.

At step S404, the client device 4 can receive one or more location parameters 316, for example, associated with a location of the client device 4 (client device location), an access point device 2 (access point device location), or both. For example, the configuration application 32 can request a user input via the user interface 29, such as via an I/O interface 322, for one or more location parameters 316. In one or more embodiments, the client device 4 can request or query a network resource 6, such as a subscriber database, a customer database, and/or a provider database, for one or more location parameters 316.

At step S406, the client device 4 determines if the one or more location parameters 316 indicate a location within a region associated with one or more AFC constraints. For example, at step S404, the user 370 can input an address and the client device 4 can use that address in a query to an AFC database to determine if the address is within a region associated with one or more AFC constraints. If the client device 4 determines that the one or more location parameters 316 are not associated with such a region (the location of the client device 4, the access point device 2, or both are not within an AFC constrained region), the process can end or proceed to step S424 of FIG. 4B where additional data is obtained to properly configure the access point device 2 with a power allowance. If the client device 4 determines that the one or more location parameters 316 are associated with such a region (the location of the client device 4, the access point device 2, or both are within an AFC constrained region) or the one or more location parameters from step S406 were not received, the process continues to step S410.

At step S410, the client device 4 receives one or more GPS measurements with each having a simultaneous or substantially simultaneous Wi-Fi range measurement via Wi-Fi Location Fine Timing to access point device 2, with each range measurement associated with a MAC address for later device correlation. The GPS measurement can be determined for example, via a GPS receiver 320. Wi-Fi Location Fine Timing functionality provides a fine timing measurement (a time-stamp in a frame) that is used with a radio wave speed so as to determine a distance, an angle of departure, or both in relation to the client device 4 and the access point device 2. If one or more GPS measurements and associated one or more Wi-Fi range measurements (for example, one or more range measurements) via Wi-Fi Location Fine Timing to access point device 2 are not received, the process continues at step S411 where the client device 4 sends a notification to the user 370, for example, via a user interface 29. The notification informs the user 370 to adjust positioning or disposition of the client device 4 so that the client device 4 is capable of receiving one or more GPS measurements and one or more associated Wi-Fi range measurement via Wi-Fi Location Fine Timing to access point device 2 at step S410. In one or more embodiments, step S411 is omitted, for example, the client device 4 can wait for the one or more GPS measurements and the one or more associated Wi-Fi range measurement via Wi-Fi Location Fine Timing to access point device 2) to be received, such as when time sensitivity is not an issue.

Steps S414 and S418, repeat the process of steps S410-S412 for the client device 4 to obtain one or more additional GPS measurements and/or one or more additional range measurements. These additional GPS and range measurements can also be stored as one or more configuration parameters 350. The one or more range measurements and one or more additional range measurements (collectively referred to as one or more range measurements) received by the client device 4 can be associated with one or more GPS measurements and one or more additional GPS measurements (collectively referred to as one or more GPS measurements), respectively, with each of the one or more range measurements associated with a MAC address (for example, the MAC address can be included in a header of the one or more range measurements) of a corresponding access point device 2. In this way, any one or more GPS measurements and one or more range measurements can be correlated with a particular access point device 2.

At step S418, the one or more GPS measurements received in step S410 and/or step S414, any of the one or more range measurements received in step S412 and/or step S416, one or more MAC addresses, one or more location parameters, or any combination thereof can be stored in a memory 31, for example, as one or more configuration parameters 350. In one or more embodiments, storing the one or more configuration parameters 350 can occur at, before, or after, any one or more steps or not at all. The process continues to step S420.

At step S420, the client device 2 determines an access point device location for access point device 2 based on a triangulation of the one or more GPS measurements from device 4 along with the one or more associated range measurements to access point device 2. For example, the one or more GPS measurements and the one or more additional GPS measurements can be triangulated. In one or more embodiments, any plurality of GPS measurements can be used for triangulation. For example, the one or more GPS measurements and/or the one or more additional GPS measurements can comprise a series of GPS measurements taken over a period of time. The client device can determine an access point device location based on the triangulation of one or more of the available or received one or more GPS measurements (such as the one or more GPS measurements from step S410 and/or one or more additional associated GPS measurements from step S414) and a distance to the access point device 2 associated with each of the one or more GPS measurements. In one or more embodiments, step S410 can be omitted, for example, if a plurality of the one or more GPS measurements are not received, or if a single GPS measurement is determined to be sufficient.

At step S422, the client device 4 receives a height information, for example, from any of a user 370, a network resource 6, any other source, or any combination thereof. The height information can be based on any of the access point device location (including a location error) determined in step S420, a latitude, a longitude, or both (for example, one or more GPS measurements) associated with the access point device 2 and/or the client device 4, any other one or more location parameters 316, or any combination thereof. As an example, the client device 4 can request height information from a network resource 6, such as a United State Geological Survey (USGS) topographical mapping database based on a latitude and a longitude determined from the access point device location determined in step S420. In one or more embodiments, the height information can be received via a user input to a user interface 29, for example, a user input that indicates any of a floor or level of a building, an elevation, or any other height information, or any combination thereof.

At step S424, the access point device 2 receives identifier information associated with the access point device, such as a serial number, a MAC address, or both associated with the access point device. The serial number, the MAC address or both can be received via any of a user input of an I/O interface to a user 322, a memory 31, a camera 324 (for example, by scanning a digital code, such as a bar code, a QR code, etc., at or about the access point device 2), any other user interface 29, or any combination thereof. In one or more embodiments, a regulatory identifier, such as an FCC certification identifier, is included within or as part of the serial number or is requested from network resource 6 based on the serial number. In one or more embodiments, step S424 is omitted and the access point device 2 provides the identifier information via, for example, a secure connection to the client device 4.

At step S426, the access point device 2 sends an AFC request message to network resource 6, such as an AFC management system. For example, the AFC request message can be an AFC Available Spectrum Inquiry request message. The AFC request message can comprise any of one or more configuration parameters 350, including, but not limited to, any of an access point device location, for example, that includes an x-y-z coordinate, a client device location, a height information, a MAC address, a serial number or associated serial number identifier, a regulatory certification identifier (such as an FCC certification identifier), an error offset, any other identifier and/or location information, or any combination thereof. In one or more embodiments, the AFC request message can comprise a MAC address and/or any other MAC information determined for the access point device 2 along with S424 MAC/SN association from the access point device 2 as the access point location and the serial number. In one or more embodiments, S424 can be avoided where the client device 4 sends a location of the access point device 2 to the access point device 2 so as to initiate an AFC response message, such as an AFC Available Spectrum Inquiry Response message that comprises the access point device location and the serial number as the access point device 2 knows the MAC to serial number relationship.

At step S428, the access point device 2 receives an AFC response message from the AFC management system. The AFC response message can comprise a transmit power allowance on a per frequency range basis for the access point device 2, an expiration time for the transmit power allowance, or both. In one or more embodiments, the access point device 2 performs steps S426 and S428. For example, the access point device 2 comprises the identifier information and uses this information stored locally at the access point device 2 or remotely at a network resource 6 to send an AFC request message, such as an AFC Available Spectrum Inquiry Request message, and to receive an AFC response message, such as an AFC Available Spectrum Inquiry Response message. In one or more embodiments, one or more other network devices, such as another client device 4, provides information required for an AFC request message, such as an Available Spectrum Inquiry Request message. In one or more embodiments, any one or more network devices can provide proxy support for accurately determining an access point device location, for example, by providing one or more GPS measurements, other location information, or both.

At step S430, the client device 4 provides and/or configures, for example, via a Wi-Fi connection 9, the access point device 2 with operation information based on the AFC response message from step S428. The operation information can comprise any of the transmit power allowance, the expiration time associated with the transmit power allowance, the determined access point device location, for example, as determined from step S420, any other operation information, or any combination thereof. The client device 4 can configure the access point device 2 based on the operation information of the AFC response message. The configuring the access point device 2 can comprise setting a power allowance as provided by the operation information. The access point device 2 can save the operation information, for example, in a memory 24, for subsequent configuration, configuring one or more radios of the access point device 2, scheduling one or more subsequent AFC request messages, or any combination thereof. In one or more embodiments, any one or more access point devices 2 can securely send the operation information associated with a particular access point devices 2 to the particular access point device 2 or any one or more other access point devices 2. In one or more embodiments, at expiration of the expiration time associated with the transmit power allowance, the access point device 2 can automatically or at predetermined time send an AFC request message, such as an AFC Available Spectrum Inquiry Request message, to the AFC management system using any of the previous stored information associated with the access point device 2 and/or any one or more other access point devices 2. In one or more embodiments, the access point device 2 performs step S430 based on the operation information receives as part of the AFC response message from step S428 received by the access point device 2. In one or more embodiments, any one or more power allowances for corresponding one or more access point devices can be obtained based on any one or more of the above described steps.

According to one or more example embodiments of inventive concepts disclosed herein, there are provided novel solutions for configuring an access point device 2 by using more accurate location information to obtain a power allowance associated with the more accurate location information so that a network environment can utilize a 6 GHz frequency band which can provide an enhanced QoE for a user. Reducing or eliminating the uncertainty of a location associated with an access point device, for example, allows a configured access point device to operate at a higher or increased power allowance without interfering with an incumbent 6 GHz wireless infrastructures or systems within the same region.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a” “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A method for a client device to configure a power allowance for an access point device comprising:
receiving one or more global positioning system (GPS) measurements associated with the client device;
receiving one or more associated range measurements to the access point device via a wireless fidelity (Wi-Fi) Location Fine Timing functionality, wherein the one or more associated range measurements are associated with the one or more GPS measurements;
determining an access point device location associated with the access point device based on the one or more GPS measurements and the one or more associated range measurements;
sending an AFC request message to an AFC management system, wherein the AFC request message is based on the access point device location;
receiving an AFC response message from the AFC management system, wherein the AFC Response message comprises the power allowance for the access point device; and
configuring the access point device based on the AFC response message.

2. The method of claim 1, wherein the AFC response message comprises a maximum transmit power allowance for the access point device, wherein configuring the access point device comprises providing the maximum transmit power allowance to the access point device.

3. The method of claim 1, further comprising:
sending a notification to a user to transition the client device prior to receiving the one or more GPS measurements, the one or more additional GPS measurements, or both.

4. The method of claim 1, further comprising:
receiving one or more additional GPS measurements associated with the client device;
receiving one or more additional associated range measurements to the access point device, wherein the one or more additional associated range measurements are associated with the one or more additional GPS measurements; and
wherein determining the access point device location is based on a triangulation of the one or more GPS measurements, the one or more additional GPS measurements, the one or more associated range measurements, and the one or more additional associated range measurements.

5. The method of claim 1, further comprising:
receiving a height information from a network resource based on a latitude and a longitude associated with the access point device location, wherein the latitude and the longitude are based on the one or more GPS measurements, the one or more additional GPS measurements, or both.

6. The method of claim 1, wherein receiving the client device location comprises receiving a user input, wherein the user input is indicative of any of an address, a zip code, information from a provider database, or any combination thereof associated with the access point device, the client device, or both.

7. The method of claim 1, further comprising:
receiving a serial number and a media access control (MAC address) via a user interface of the client device; and
wherein the AFC request message comprises the serial number and the MAC address.

8. A client point device that configures a power allowance for an access point device comprising:
a memory; and
a processor configured to execute one or more instructions stored on the memory to cause the client device to:
receive one or more global positioning system (GPS) measurements associated with the client device;
receive one or more associated range measurements to the access point device via a wireless fidelity (Wi-Fi) Location Fine Timing functionality, wherein the one or more associated range measurements are associated with the one or more GPS measurements;
determine an access point device location associated with the access point device based on the one or more GPS measurements and the one or more associated range measurements;
send an AFC request message to an AFC management system, wherein the AFC request message is based on the access point device location;
receive an AFC response message from the AFC management system, wherein the AFC response message comprises the power allowance for the access point device; and
configure the access point device based on the AFC response message.

9. The client device of claim 8, wherein the AFC response message comprises a maximum transmit power allowance for the access point device, wherein configuring the access point device comprises providing the maximum transmit power allowance to the access point device.

10. The client device of claim 8, wherein the processor is further configured to execute the one or more instructions to further cause the client device to:
send a notification to a user to transition the client device prior to receiving the one or more GPS measurements, the one or more additional GPS measurements, or both.

11. The client device of claim 8, wherein the processor is further configured to execute the one or more instructions to further cause the client device to:
receive one or more additional GPS measurements associated with the client device;
receive one or more additional associated range measurements to the access point device, wherein the one or more additional associated range measurements are associated with the one or more additional GPS measurements; and
wherein determining the access point device location is based on a triangulation of the one or more GPS measurements, the one or more additional GPS measurements, the one or more associated range measurements, and the one or more additional associated range measurements.

12. The client device of claim 8, wherein the processor is further configured to execute the one or more instructions to further cause the client device to:
receive a height information from a network resource based on a latitude and a longitude associated with the access point device location, wherein the latitude and the longitude are based on the one or more GPS measurements, the one or more additional GPS measurements, or both.

13. The client device of claim 8, wherein receiving the client device location comprises receiving a user input, wherein the user input is indicative of any of an address, a zip code, information from a provider database, or any combination thereof associated with the access point device, the client device, or both.

14. The Liens device of claim 8, wherein the processor is further configured to execute the one or more instructions to further cause the client device to:
receive a serial number and a media access control (MAC address) via a user interface of the client device; and
wherein the AFC request message comprises the serial number and the MAC address.

15. A non-transitory computer-readable medium of a client device storing one or more computer-readable instructions for configuring a power allowance for an access point device, that when executed by a processor, cause the processor to perform one or more operations comprising:
receiving one or more global positioning system (GPS) measurements associated with the client device;
receiving one or more associated range measurements to the access point device via a wireless fidelity (Wi-Fi) Location Fine Timing functionality, wherein the one or more associated range measurements are associated with the one or more GPS measurements;
determining an access point device location associated with the access point device based on the one or more GPS measurements and the one or more associated range measurements;
sending an AFC request message to an AFC management system, wherein the AFC request message is based on the access point device location;
receiving an AFC response message from the AFC management system, wherein the AFC response message comprises the power allowance for the access point device; and
configuring the access point device based on the AFC response message.

16. The non-transitory computer-readable medium of claim 15, wherein the AFC response message comprises a maximum transmit power allowance for the access point device, wherein configuring the access point device comprises providing the maximum transmit power allowance to the access point device.

17. The non-transitory computer-readable medium of claim 15, wherein the one or more computer-readable instructions when executed by the processor, further cause the processor to perform one or more operations further comprising:
sending a notification to a user to transition the client device prior to receiving the one or more GPS measurements, the one or more additional GPS measurements, or both.

18. The non-transitory computer-readable medium of claim 15, wherein the one or more computer-readable instructions when executed by the processor, further cause the processor to perform one or more operations further comprising:
receiving one or more additional GPS measurements associated with the client device;
receiving one or more additional associated range measurements to the access point device, wherein the one or more additional associated range measurements are associated with the one or more additional GPS measurements; and
wherein determining the access point device location is based on a triangulation of the one or more GPS measurements, the one or more additional GPS measurements, the one or more associated range measurements, and the one or more additional associated range measurements.

19. The non-transitory computer-readable medium of claim 15, wherein the one or more computer-readable instructions when executed by the processor, further cause the processor to perform one or more operations further comprising at least one of:
receiving a height information from a network resource based on a latitude and a longitude associated with the access point device location, wherein the latitude and the longitude are based on the one or more GPS measurements, the one or more additional GPS measurements, or both; and
receiving a serial number and a media access control (MAC address) via a user interface of the client device, wherein the AFC request message comprises the serial number and the MAC address.

20. The non-transitory computer-readable medium of claim 15, wherein receiving the client device location comprises receiving a user input, wherein the user input is indicative of any of an address, a zip code, information from a provider database, or any combination thereof associated with the access point device, the client device, or both.
